(19) United States
(12) Patent Application Publication
(10) Pub. No.: US 2021/0037973 A1
(43) Pub. Date: Feb. 11, 2021

(54) INTELLIGENT CABINET ACCESS CONTROLLER

(71) Applicants: Oladayo Luke, Severn, MD (US); Olamide Luke, Severn, MD (US)

(72) Inventors: Oladayo Luke, Severn, MD (US); Olamide Luke, Severn, MD (US)

(21) Appl. No.: 16/536,859

(22) Filed: Aug. 9, 2019

(51) Int. Cl. A47B 88/90; E05B 65/46; E05B 39/00; E05B 45/06; G07F 17/12

(52) U.S. Cl. CPC A47B 88/90; E05B 65/46; G07F 17/12; E05B 45/06; E05B 39/00

(57) ABSTRACT

The present invention is related to an intelligent controlled secure cabinet/drawer. The present invention provides advance and innovative cabinet/drawer which includes auto locking, easy item finding capability and touch-release features. An intelligent secure cabinet or drawer comprising an installable apparatus for controlling access by persons to identify and locate the items of the cabinet or drawer further comprising mounted drive shafts for automatic open or close and lock mechanism, a knob with on and off switch to control the cabinet or drawer to open or close, a mounting base, a unique motor enabled auto lock, an external and/or internal camera, a WIFI sensor and a pressure sensor. Furthermore, the Present invention also includes mounting base to enable easy relocation or removal of the device, microcontroller, and forced entry sound alarm. It also contains motor to drive open and close directions, it will automatically change direction when interrupted. Furthermore, this present invention provides routine learning (users specified routine or learn user's routine to lock and unlock the cabinet/drawer). The on/off switch and locking mechanism in auto opener is unique and provides additional level of security. Because of these above mentions advance features, users gain greater protection, superior efficiency, and more enjoyable experiences.

### CROSS-REFERENCE TO RELATED APPLICATIONS

No related applications are previously filed.

### FIELD OF THE INVENTION

The subject matter described herein relates generally to the field of cabinetry. In particular, the subject matter described herein relates to the intelligent cabinetry with locking mechanism to securely store and/or controllably distribute items, instruments, articles, products, and the like.

### BACKGROUND OF THE INVENTION

The traditional cabinet or drawer are only capable of storing items. In some instances, some people have a habit of placing items in the cabinet or drawer and forget. In this scenario, sometimes due to forgetfulness and short time memory it is difficult for some people to remember the location of items in the cabinet or drawer. In some instances, people place an item in cabinet and drawer and try to search for the same all over the house. In this regard, there is a need of an intelligent cabinet or drawer that is useful to cleverly identify the items or products stored in them. The present invention provides an intelligent controlled secure and innovative cabinet/drawer which includes auto locking, easy item finding capability and touch-release features. So that, users gain greater protection, superior efficiency, and more enjoyable experiences.

### RELEVANT PATENT APPLICATIONS

| Pat. No. | Title of Invention |
|---|---|
| CN201212952Y | Intelligent machine cabinet |
| CN2767605Y | Intelligent cabinet control device |
| CN1328996C | Intelligent integration equipment in integral kitchen |
| CN201238784Y | Intelligent storing cabinet |
| CN104217502A | Intelligent control method of cabinet system |

### SUMMARY OF THE INVENTION

Contrary to the yester years, now a day's customer and user expectations, and technological possibilities have evolved dramatically. The cabinet/drawer security solution and smartness no longer meet their needs. In addition, cabinet door is not smart, and items are sometimes difficult to find due to forgetfulness/short time memory of our nature. The innovative smart cabinets/drawers that contain valuable items can increase additional security layer and easy item finding over old-style cabinet/drawer system. Present invention is a combination of camera, pressure sensor, opening nub/knob, Phone/PC/tablet app to control the device, lock mechanism, mounting base for to enable easy relocation or removal of the device, microcontroller, and forced entry sound alarm. It also contains motor to drive open and close directions and can automatically change direction when interrupted. Furthermore, this present invention provides routine learning (users specified routine or learn user's routine to lock and unlock the cabinet door/drawer) and the searching capability provides easier access to find item where users won't have to open multiple cabinet to find the relevant item. The on/off switch and locking mechanism in auto opener is unique and provides additional level of security.

### BRIEF DESCRIPTION OF THE SEVERAL VIEWS OF THE DRAWINGS

Following drawings with reference numbers and exemplary embodiments are referenced for explanation purpose.

FIG. 1 illustrates the top view of the intelligent drawer and a detailed view of apparatus for controlling access.

FIG. 2 illustrates the perspective view of the intelligent cabinet and a detailed view of apparatus for controlling access.

FIG. 3 illustrates the side view of the intelligent cabinet, a side sectional view of knob and detailed view of apparatus for controlling access.

FIG. 4 illustrates the logical workflow of the intelligent cabinet/drawer.

### DETAIL DESCRIPTION OF THE DRAWINGS

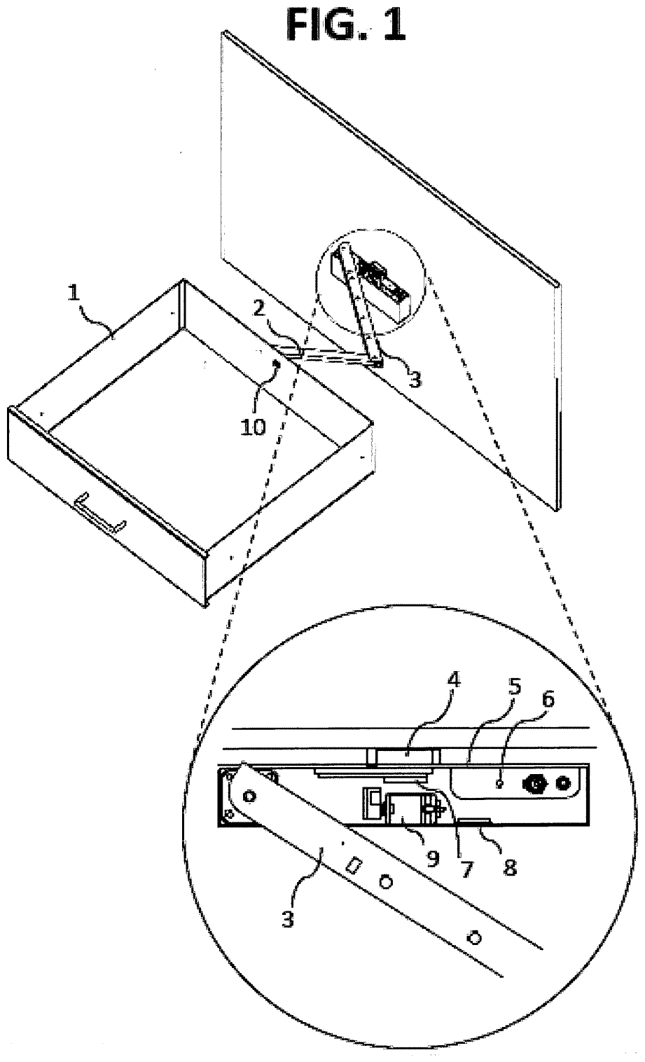

In present invention FIG. 1 illustrate an example of the basic drawer diagram which includes upper view of the Drawer 1, a Rod (i) 2, a Rod (ii) 3, Mounting base 4, Casing 5, Batteries 6, PCB 7, WIFI sensor 8, lock mechanism with motor 9, camera 10.

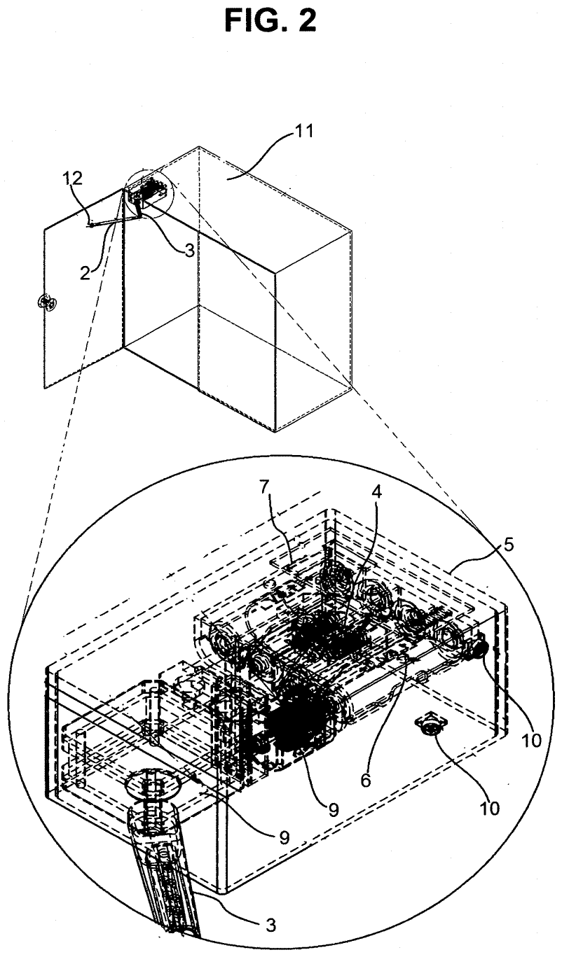

FIG. 2 visualizes the perspective view of the intelligent cabinet 11 and a detailed view of apparatus for controlling access, which further contains a hinge 12, a Rod (i) 2, a Rod (ii) 3, Mounting base 4, Casing 5, Batteries 6, PCB 7, Lock mechanism with Motor 9, and Camera 10.

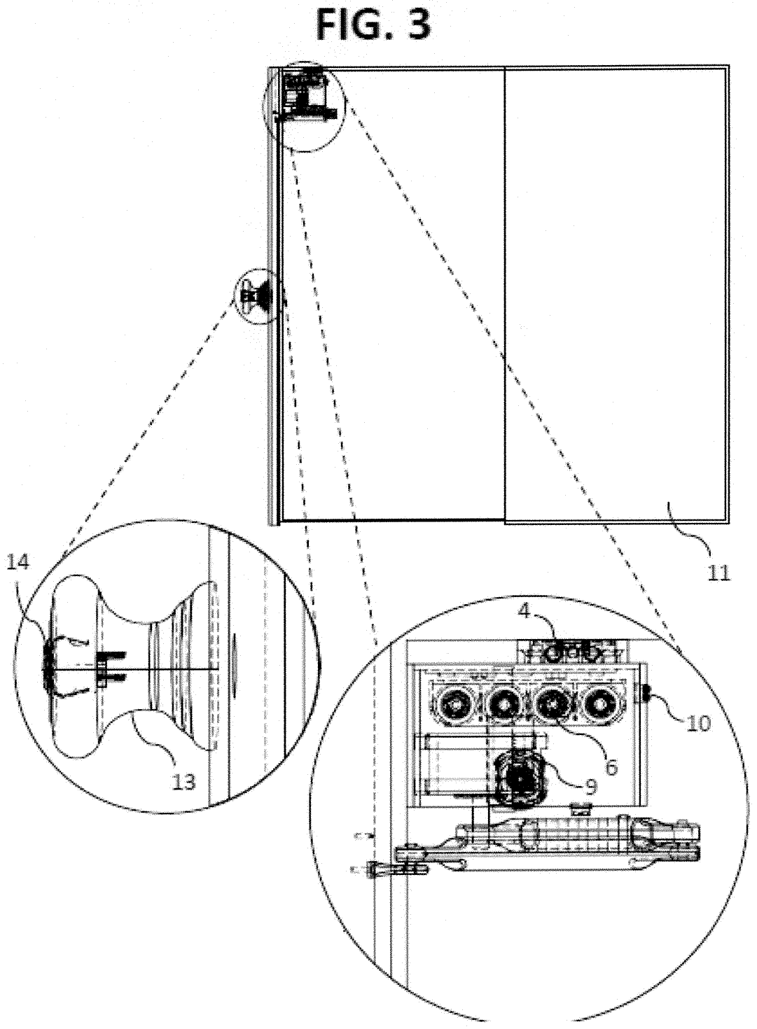

FIG. 3 illustrates the side view of the intelligent cabinet 11, which further includes a side sectional view of knob 13 and Push button 14, and detailed view of apparatus that includes Mounting base 4, Batteries 6, Lock mechanism with Motor 9, and Camera 10.

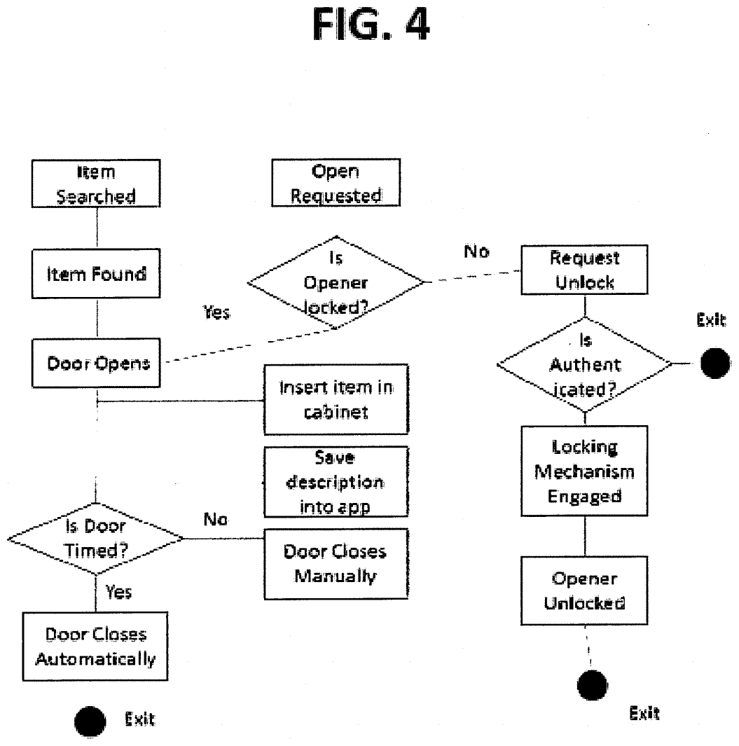

FIG. 4 illustrates the logical workflow of the intelligent cabinet/drawer. The flow diagram firstly describes the auto open or close mechanism that can be operated via Phone/PC/Tablet app. The Phone/PC/Tablet app further enables user to search the required item in multiple cabinet 11/drawer 1 at once and automatically directs the specific cabinet 11/drawer 1 to open in which the specific item has been stored. At this time, user can remove/insert item, and simultaneously save description into the Phone/PC/Tablet app. Further, if automatic close mechanism is activated, the drawer 1 or door of cabinet 11 will close automatically, otherwise the drawer 1 or door of cabinet 11 can be closed manually with the help of push button 14 embedded in the knob 13 of the door of cabinet 11.

In another situation, the intelligent cabinet 11/drawer 1 has a capability to detect force opening and directs signal to sound alarm.

### DETAILED DESCRIPTION OF THE INVENTION

The present invention provides innovative smart cabinets and item finding capability with self-learning capability to provide additional level of security. The smart cabinet/drawer system comprises of a cabinet 11/drawer 1, pressure sensor, opening knob 13, Phone/PC/Tablet app to control the device, lock mechanism with motor 9, mounting base 4 to enable easy relocation or removal of the device, microcontroller, camera 10 with forced entry sound alarm. Furthermore, it contains motor 9 to drive open and close directions and can automatically change direction when interrupted.

In the present invention, the cabinet 11 door opener will carry two cameras 10 (one camera 10 to view item, the other camera 10 to identify the person opening the cabinet 11/drawer 1). User can take picture of item stored in a drawer 1 and save it into the Phone/PC/Tablet app for later reference. Moreover, the item stored in the cabinet 11/drawer 1 can be saved and viewed by description on the Phone/PC/Tablet app.

In the present invention, there are a three method of operations. Firstly, manual or by hand, secondly by push button 14 embedded in the knob 13, and thirdly via Phone/PC/Tablet app.

In the present invention, if there are multiple items stored with the same name in the cabinet 11/drawer 1, user can view the stored item via camera 10 or can use insertion date to guess the right item. In another situation, the Phone/PC/Tablet app will ask to describe the item and that description will be further helpful to identify the right item (description will be asked when inserting the item though it will be an optional requirement).

In the present invention, the intelligent drawer 1 or door of cabinet 11 automatically closes after user specified time in the Phone/PC/Tablet app. This will further reduce the risks of theft when the drawer 1 or door of cabinet 11 are accidentally left opened or unlocked.

In the present invention, the intelligent cabinet 11/drawer 1 contains motor 9 to drive open and close direction. Moreover, it will automatically, change direction when interrupted.

The present invention provides additional level of security to safeguard important files, medications, guns, valuable items like jewelry etc. In addition, it provides a second level of security, when key lock and opener lock are activated.

The present invention is useful in offices, kitchen, workshop cabinets, save box (e.g. banks vault drawers) etc.

The present invention has pressure sensor which helps the drawer 1 or door of cabinet 11 to automatically close/open when a small push/pull force is applied.

In the present invention, the intelligent cabinet 11/drawer 1 has routine learning capability; it will automatically learn user routine to lock and unlock the drawer 1 or door of cabinet 11.

The present invention will detect the force entry and will sound alarm.

In the present invention FIG. 4 depicts a flow diagram embodiment that showing working mechanism of the invention.

The flow diagram firstly describes the auto open or close mechanism that can be operated via Phone/PC/Tablet app. The Phone/PC/Tablet app further enables user to search the required item in multiple cabinet 11/drawer 1 at once and automatically directs the specific cabinet 11/drawer 1 to open in which the specific item has been stored. At this time, user can remove/insert item, and simultaneously save description into the Phone/PC/Tablet app. Further, if automatic close mechanism is activated, the drawer 1 or door of cabinet 11 will close automatically, otherwise the drawer 1 or door of cabinet 11 can be closed manually with the help of push button 14 embedded in the knob 13 of the door of cabinet 11.

In another situation, the intelligent cabinet 11/drawer 1 has a capability to detect force opening and directs signal to sound alarm.

I/We claim:

1. An intelligent controlled secure cabinet or drawer comprising:
an installable apparatus for controlling access by persons to identify and locate the items of the cabinet or drawer further comprising:
mounted drive shafts for automatic open or close and lock mechanism;
a knob with on and off switch to control the cabinet or drawer to open or close;
a mounting base;
a unique motor enabled auto lock;
an external and/or internal camera;
a WIFI sensor;
a pressure sensor.

2. The intelligent controlled secure cabinet or drawer claimed as claim 1, wherein the drawer or the doors of the cabinet includes pressor sensor which close when a small force is applied to close and opens when a small open force is applied.

3. The intelligent controlled secure cabinet or drawer claimed as claim 1, wherein the drawer or the doors of the cabinet can automatically change direction to open or close when interrupted.

4. The intelligent controlled secure cabinet or drawer claimed as claim 1, wherein connected to a phone, PC and tablet app that has an ability to control multiple cabinet or drawer.

5. The intelligent controlled secure cabinet or drawer claimed as claim 1, wherein the mounting base enables easy relocation/removal of the installed apparatus.

6. The intelligent controlled secure cabinet or drawer claimed as claim 1, wherein the internal camera is used to view items of the cabinet or drawer and the internal camera is used to view the person opening the cabinet or drawer.

7. The intelligent controlled secure cabinet or drawer claimed as claim 1, wherein the item/product placed in the cabinet or drawer can be saved and viewed by description on the phone app.

8. The intelligent controlled secure cabinet or drawer claimed as claim 1, wherein the user can take picture of item/product placed in the cabinet or drawer and save the picture into the phone app for later reference.

9. The intelligent controlled secure cabinet or drawer claimed as claim 1, wherein can be operated manually by hand or by using push button embedded in the knob or via phone app.

10. The intelligent controlled secure cabinet or drawer claimed as claim 1, wherein the drawer or the doors of the cabinet can be instructed to automatically close or open during a specified time via phone app.

11. The intelligent controlled secure cabinet or drawer claimed as claim 1, wherein has a capability to self-learn from the user routing to lock and unlock cabinet or drawer.

12. The intelligent controlled secure cabinet or drawer claimed as claim 1, wherein has a capability to detect force opening and directs signal to sound alarm.
